(19) United States
(12) Patent Application Publication
(10) Pub. No.: US 2012/0194040 A1
(43) Pub. Date: Aug. 2, 2012

(54) High Torque Density and Low Torque Ripple Actuator System

(75) Inventors: Lei Hao, Troy, MI (US); Chandra S. Namuduri, Troy, MI (US)

(73) Assignee: GM GLOBAL TECHNOLOGY OPERATIONS LLC, Detroit, MI (US)

(21) Appl. No.: 13/017,331

(22) Filed: Jan. 31, 2011

(51) Int. Cl. H02K 11/04

(52) U.S. Cl. 310/68 D

(57) ABSTRACT

A permanent magnet electric machine drive system that includes a plurality of magnets for generating a first magnetic field and a stator is disposed radially outward from the plurality of magnets for generating a magnetic field. The stator includes a plurality of stator poles separated by slots with each respective stator pole having a concentrated winding with a respective number of turns formed around each respective stator pole. Each respective concentrated winding within the stator comprising non-overlapping phases. The concentrated windings form a dual three-phase winding configuration that includes a first set of three-balanced phase windings and a second set of three-balanced phase windings. The first set of three-balanced phase windings is phase shifted in the range of 15 to 45 electrical degrees from the second set of three-balanced phase windings for reducing the torque ripple.

### BACKGROUND OF INVENTION

An embodiment relates generally to permanent magnet motor drive system.

Electric machines are typically designed to achieve a specific operating characteristic. AC electric machines with drag cup rotors have very low inertia properties. AC Induction machines typically exhibit ripple-free torque properties, whereas conventional AC brushless permanent magnet synchronous machines exhibit high torque to ampere ratios. However, achieving a respective specific operating characteristic typically results in the sacrifice of other operating characteristics. Inverter-based motor drive systems are used to control speed and torque of the AC motor. While inverter-based motor drive systems may reduce torque ripple, such systems are complex and expensive. Such systems typically are large in size and introduce EMI to the vehicle electrical system.

### SUMMARY OF INVENTION

An advantage of an embodiment of the invention is a permanent magnet electric machine drive system that provides optimal operating characteristics such as low torque ripple while generating high torque to ampere ratio and a high torque to inertia ratio.

An embodiment includes a motor drive system for producing high torque density and low torque ripple. The motor drive system includes a permanent magnet electric machine for producing AC power. The permanent magnet electric machine comprises a plurality of magnets for generating a first magnetic field. Each respective magnet represents a respective rotor pole. The plurality of magnets being positioned in a circular configuration. The electric machine further comprises a stator disposed radially outward from the plurality of magnets for generating a magnetic field. The plurality of magnets and the stator have an air gap formed therebetween. The stator includes a plurality of stator poles separated by slots with each respective stator pole having a concentrated winding with a respective number of turns formed around each respective stator pole. Each respective concentrated winding within the stator comprises non-overlapping phases. The concentrated windings increase an active length of the windings of the stator and reduce an overhang of each respective winding with respect to each stator pole for improving torque density and machine efficiency. A diode bridge rectifier converts the AC power generated by the permanent magnet electric machine to a DC power. The concentrated windings form a dual three-phase winding configuration that includes a first set of balanced three-phase windings and a second set of balanced three-phase windings. The first set of balanced three-phase windings is phase shifted in the range of 15 to 45 electrical degrees from the second set of balanced three-phase windings for reducing the torque ripple.

An embodiment includes a permanent magnet electric machine, diode bridge rectifier and power control unit. A permanent magnet electric machine that includes a plurality of magnets for generating a first magnetic field. Each respective magnet represents a respective rotor pole. The plurality of magnets being positioned in a circular configuration. A stator is disposed radially outward from the plurality of magnets for generating a magnetic field. The plurality of magnets and the stator having an air gap formed therebetween. The stator includes a plurality of stator poles separated by slots with each respective stator pole having a concentrated winding with a respective number of turns formed around each respective stator pole. Each respective concentrated winding within the stator comprising non-overlapping phases. If machine overall length is same, the concentrated windings increase the active length of the stator by reducing an overhang of each respective winding with respect to each stator pole for improving torque density and machine efficiency. The concentrated windings form a dual three-phase winding configuration that includes a first set of three-balanced phase windings and a second set of three-balanced phase windings. The first set of three-balanced phase windings is phase shifted in the range of 15 to 45 electrical degrees from the second set of three-balanced phase windings for reducing the torque ripple. A diode bridge rectifier is used to convert AC power generated by PM machine to DC power. The power control unit is employed to control power (i.e. torque) flow from the PM machine to the electrical load. Power control unit may be buck, buck boost and boost topologies.

### BRIEF DESCRIPTION OF DRAWINGS

FIG. 1 is an electrical schematic of a motor drive system with high torque and low torque ripple having dual balanced 3-phase windings.

FIG. 2 is an exemplary winding diagram of a concentrated winding configuration for an electric machine with two sets of balanced three-phase windings

FIG. 3 is an electrical schematic of a concentrated winding configuration for a first phase of the electric machine with dual balanced 3-phase windings.

FIG. 4 is an electrical schematic of a concentrated winding configuration for a second phase of the permanent magnet electric machine with dual balanced 3-phase windings.

FIG. 5 is an electrical schematic of a concentrated winding configuration for a third phase of the permanent magnet electric machine with dual balanced 3-phase windings.

FIG. 6 is an electrical schematic of a winding configuration illustrating non-overlapping for a concentrated winding configuration.

FIG. 7 is a table illustrating optimized rotor pole to stator slot combinations.

FIG. 8 is a plot of the back emf generated by the permanent magnet electric machine with dual balanced 3-phase windings.

FIG. 9 is a plot of torque generated by each set of two sets of the balanced three phase windings of the permanent magnet electric machine drive system.

FIG. 10 is a plot of the resultant torque ripple for a preferred embodiment of the motor drive system.

### DETAILED DESCRIPTION

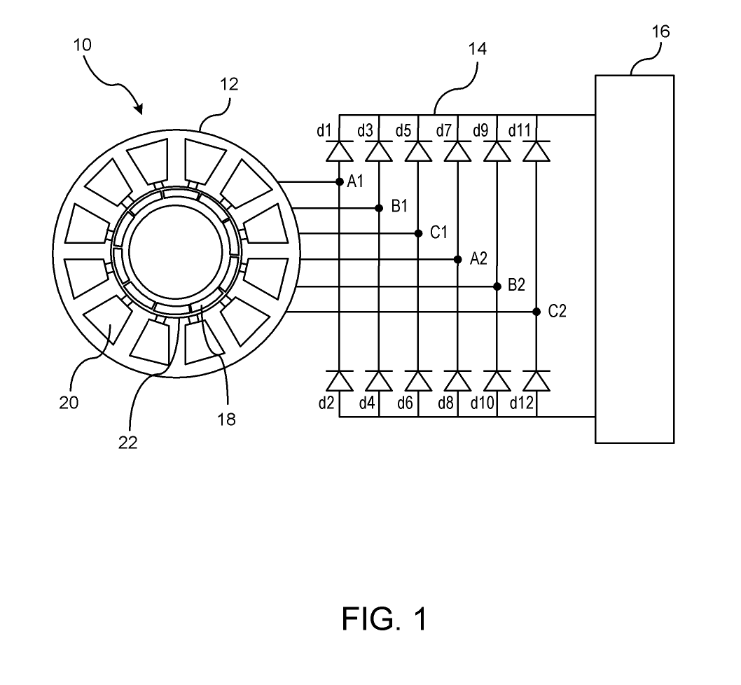

Referring to FIG. 1 there is shown a high-torque actuator system 10 that generates a low torque ripple. The high-torque actuator system 10 includes a permanent magnet electric machine 12 coupled to a diode bridge 14 and a power control unit 16. The high-torque actuator system 10 as described herein may be used for devices and systems that require high torque and fast response times such as semi-active or active suspension systems, electric power steering systems, or electromechanical braking systems. The high-torque actuator system 10 as described herein achieves a low torque ripple utilizing the diode bridge 14 and a simplified power control unit 16. The power control unit is used to control power (i.e. torque) flow from the PM machine to the electrical load. Power control unit may be buck, buck boost and boost topologies. The permanent magnet electric machine 12 includes a plurality of permanent magnets 18 spaced from a stator 20 that includes a plurality of stator windings. The stator 20 preferably has concentrated windings that are non-overlapping windings.

The plurality of magnets 18 is disposed radially inward from the stator 20. The plurality of magnets 18 is retained by a magnet holder in a cylindrical configuration. The stator 20 is disposed radially outward from the plurality of magnets 18 by a respective distance thereby forming an air gap 22 therebetween. The plurality of magnets 18 and the stator 20 cooperatively generate currents for creating an electromagnetic field which is converted into mechanical energy in the form of a torque.

The diode bridge 14 is preferably a six-leg diode bridge that converts the AC power generated by the actuator to a DC power. The diode bridge 14 is electrically coupled to the permanent magnet electric motor 10 that is a PM machine with dual balanced 3-phase windings (e.g., A1-B1-C1 and A2-B2-C2).

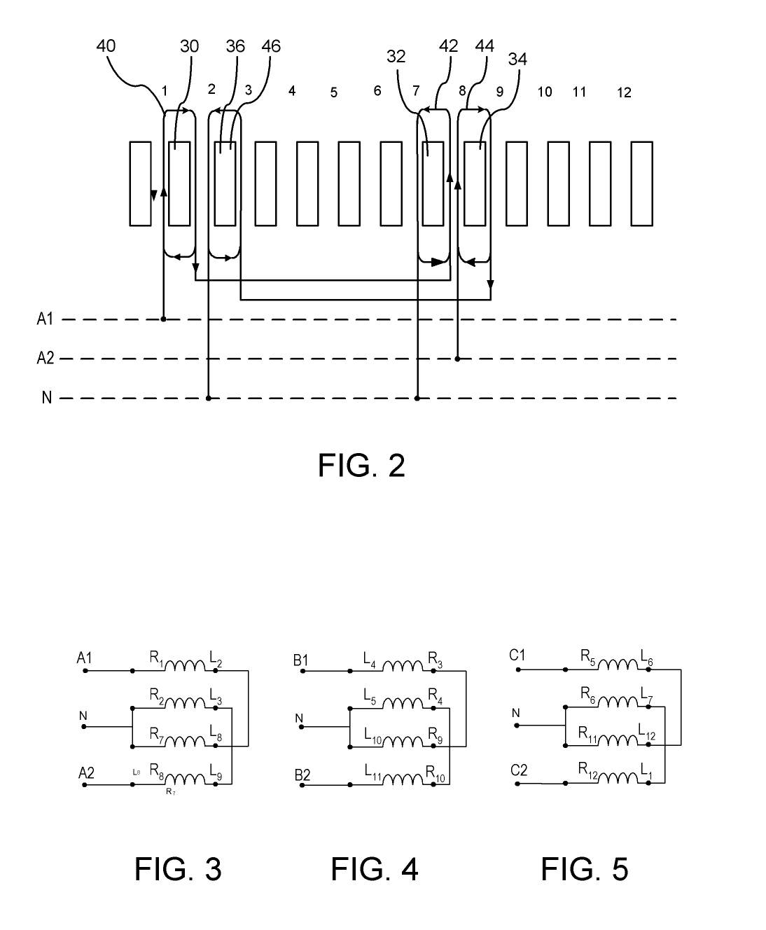

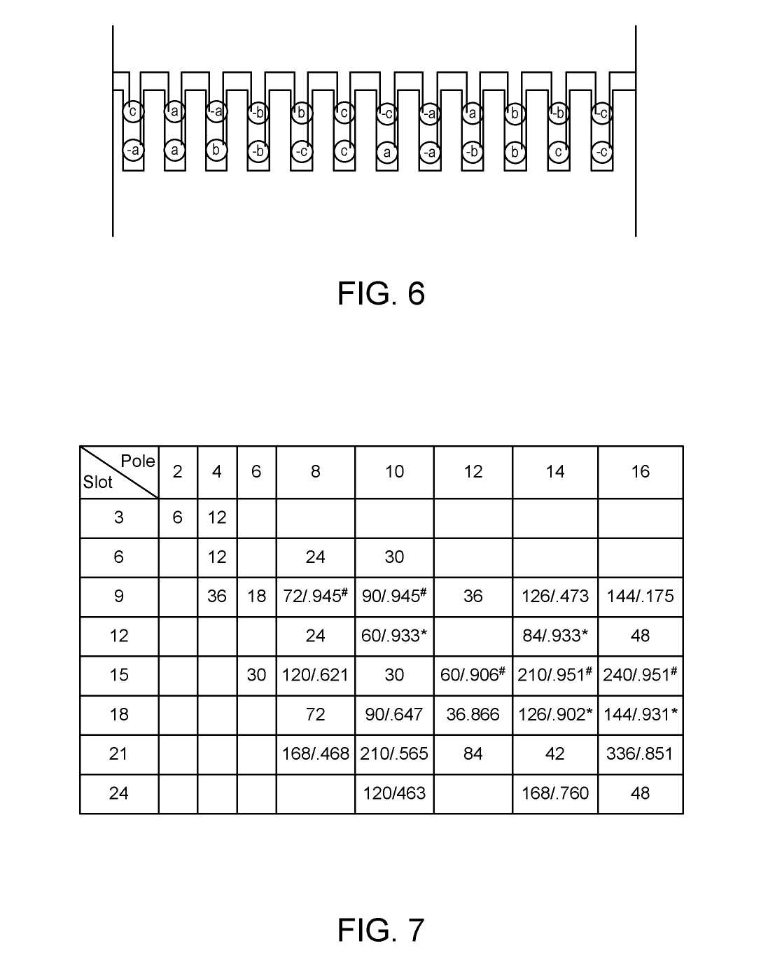

FIG. 2 illustrates a winding diagram of the concentrated winding. In contrast to this concentrated winding, a conventional overlapping winding configuration (not shown) includes winding a respective stator pole using only a single pass before proceeding to a next pole assuming slot/pole/phase is equal to 1. The winding of a conventional overlapping configuration is continued in succession to the following pole thereby ultimately returning to each previously wound pole to add additional turns around the stator pole. As a result, the number of exit wires that electrically connect the successive stator poles will be equal to the number of turns formed on each stator pole. The plurality of exit wires for a conventional winding between successive poles overlap one another thereby creating an overhang extending axially outward from the stator core. In the preferred embodiment, shown in FIG. 2, only a single exit wire electrically connects a respective pair of stator poles. The single non-overlapping exit wire results in a significantly reduced overhang in comparison to the conventional lap winding configuration. The reduction in the overhang results in an increase in the active length of the stator for increasing the torque density and the elimination of overlapping results in the possibilities of segmented stator for increasing the slot fill factor of stator which further increase torque density. In the concentrated winding configuration, the majority of the overall winding is formed as part of the turns as opposed to the exit wires coupling the respective turns, thereby concentrating the length of the entire winding to each of the respective stator poles. This results in reducing the stator copper loss and improving efficiency of the electrical machine. The reduced length of end turns, in comparison to the conventional winding, results in longer active stator length thereby achieving a high torque to ampere ratio or high power density for the same operating range. As a result of the improved efficiency, the increased machine power density has minimal impact on its thermal performance.

FIGS. 3-5 illustrate a preferred embodiment of the concentrated winding configuration for each of the two sets of the balanced three-phase windings. FIG. 3 illustrates a two set phase winding for phase A1 and phase A2. FIG. 4 illustrates a two set phase winding for phase B1 and phase B2. FIG. 5 illustrates a two set phase winding for phase C1 and phase C2. The nomenclature describe in FIGS. 3-5 is as follows: R represents the right hand of a respective slot and the L represents the left hand side of the respective slot. The subscript represents the respective slot number.

Referring to both FIGS. 2 and 3, the stator winding of the machine, is wound as two sets of balanced three-phase windings (e.g., A1 and A2) for the actuator. A respective pair of successively wound stator poles is represented by stator pole 30, 32, 34, and 36. The two-sets of windings as shown include stator slots 1, 2, 3, 7, 8, and 9. In FIG. 2, a first winding 40 is formed around stator pole 30 with a predetermined number of turns before an exit wire exits stator pole 30 and continues uninterrupted to the next stator pole 32. At stator pole 32, a second winding 42 is formed by continuously winding stator pole 32 with the predetermined number of turns. The windings around stator poles 30 and 32 are electrically coupled to phase A1. The second winding 42 thereafter electrically couples to a neutral point N. A next successive pair of stator poles is electrically to phase A2 using the concentrated winding configuration. As shown in FIG. 2, a third winding 44 is formed around stator pole 34 with a predetermined number of turns before an exit wire exits stator pole 34 and continues uninterrupted to the next stator pole 36. At stator pole 36, a fourth winding 46 is formed by continuously winding stator pole 36 with the predetermined number of turns. The windings around stator poles 34 and 36 are electrically coupled to phase A2. The fourth winding 42 thereafter electrically couples to a neutral point N. The winding pattern is repeated for each of the remaining successive pair of stator poles of the respective stator until two sets of three-balanced phase windings are completed. Each set of three-balanced phase winding has 120 degree electrical phase shift. The phase shift between two sets of three-balanced phase winding can be an arbitrary value in the range of 15 to 45 electrical degrees. However, a phase shift of about 30 electrical degrees is preferred since it can minimize torque ripple as will be discussed later.

In utilizing the electric machine with concentrated windings, an increased number of rotor poles (i.e., magnets) in comparison to a conventional rotor may be preferably used. Increasing the number of poles allows the thickness of the stator and rotor core to be reduced without the compromising the machine torque. Reduction of the stator core thickness results in an overall weight reduction of the electrical machine. Reduction of the rotor core thickness results in a lower torque to inertia ratio which results in a fast response time. Moreover, the increase in the number of poles in the electrical machine also generates sinusoidal back emf which provides an advantage of reducing torque ripple.

It should be understood that a respective pole/slot combination may be selected for optimizing the torque output by the electric machine in addition to decreasing the current draw and torque ripple. FIG. 7 illustrates a table identifying a rotor pole (i.e., magnets) to stator slot combination. The table identifies a least common multiple (LCM) factor between the rotor pole and stator slot combination, and in addition, a winding factor is shown in certain combinations. The (LCM) is the smallest whole number that is divisible by each of the combination values. The higher the LCM factor, the lower torque ripple that is generated. Preferably, a rotor pole and slot combination having a LCM of at least 36 is selected. Preferred choice combinations include 10 rotor pole/12 stator slot, 14 rotor pole/12 stator slot, 14 rotor pole/18 stator slot, or 16 rotor pole/18 stator slot combinations.

The winding factor is defined by the ratio of flux linked by an actual winding to flux that would have been linked by a full pitch concentrated winding with the same number of turns. The higher the winding factor value, the higher the torque density. Preferably, a winding factor of greater than 0.7 is selected.

When selecting a combination which affords the advantages described herein, a combination offering the highest LCM and the highest winding factor is desirable. However, selecting the combination with the highest LCM and winding factor has drawbacks. For example, those combinations having an odd number of stator slots can induce unbalanced magnetic pull which results in vibration. Combinations that are acceptable selections are those identified with an asterisk notation (*). Those combinations having a high LCM values and winding factors but are subject to vibration are those with an odd number of slots and are represented with a # notation.

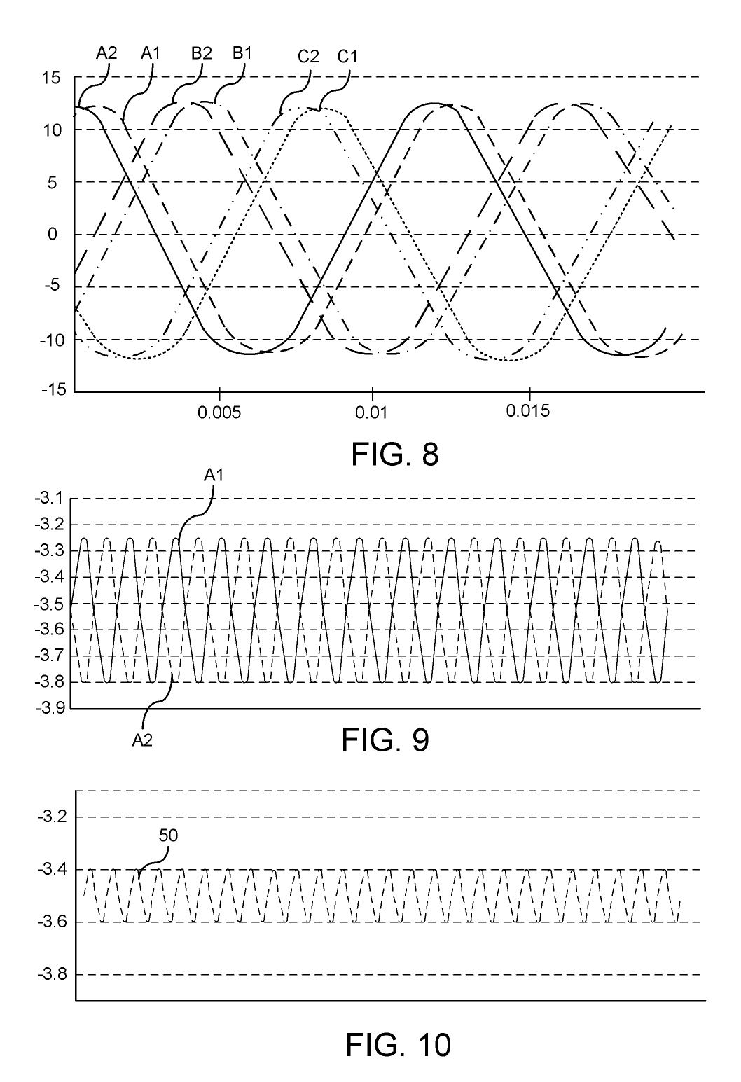

FIG. 8 illustrates the back emf generated by the permanent magnet electric machine in each winding A1, A2, B1, B2, C1, C2. As shown, the back emf of the first set of each phase is phase shifted by 30 electrical degrees from the back emf of the second set of the corresponding phases. For example, phase A1 and phase A2 have a 30 degree phase shift, phase B1 and phase B2 have a 30 degree phase shift, and phase C1 and phase C2 have a 30 degree phase shift. Alternatively, the phase shift between the first set of three-balanced phase windings and the second set of three-balanced phase windings may be in the range of 15-45 electrical degrees which will provide the reduced torque ripple effect.

FIG. 9 illustrates the torque generated by each set of the dual balanced three-phase windings (e.g., A1-B1-C1 and A2-B2-C2). The negative torque indicates that system operates as generator. As shown, the two winding sets A1-B1-C1 and A2-B2-C2 generate a same amount of torque assuming the two sets of three phase winding have the same number of turns as one set of three phase winding. However, the overall torque ripple is minimized by optimally phase shifting the two sets of three-balanced phase windings relative to one another. Effect of a 30 electrical degree phase shift between the two sets of the phase windings is shown in FIG. 9 which generates a reduced torque ripple when the torque generated by the two phase sets are added together. In FIG. 9, it is shown that the torque ripple due to one set of the dual balanced three-phase windings is 0.55 Nm. FIG. 10 illustrates the total torque ripple 50 after torque generated by the two phase sets are added together. As shown in FIG. 10, the torque ripple is reduced to 0.19 Nm. The result of the reduced torque ripple is reduced noise resulting in quieter operation of the permanent magnet electric motor. Moreover, efficiency of the permanent electric machine is improved.

While certain embodiments of the present invention have been described in detail, those familiar with the art to which this invention relates will recognize various alternative designs and embodiments for practicing the invention as defined by the following claims.

What is claimed is:

1. A motor drive system for producing high torque density and low torque ripple, the motor drive system comprising:
a permanent magnet electric machine for producing AC power, the permanent magnet electric machine comprising:
a plurality of magnets for generating a first magnetic field, each respective magnet representing a respective rotor pole, the plurality of magnets being positioned in a circular configuration;
a stator disposed radially outward from the plurality of magnets for generating a magnetic field, the plurality of magnets and the stator having an air gap formed therebetween, the stator including a plurality of stator poles separated by slots with each respective stator pole having a concentrated winding with a respective number of turns formed around each respective stator pole, each respective concentrated winding within the stator comprising non-overlapping phases, wherein the concentrated windings increase an active length of the windings of the stator and reduce an overhang of each respective winding with respect to each stator pole for improving torque density and machine efficiency; and
a diode bridge rectifier for converting the AC power generated by the permanent magnet electric machine to a DC power;
wherein the concentrated windings form a dual three-phase winding configuration that includes a first set of balanced three-phase windings and a second set of balanced three-phase windings, wherein the first set of balanced three-phase windings is phase shifted in the range of 15 to 45 electrical degrees from the second set of balanced three-phase windings for reducing the torque ripple.

2. The motor drive system of claim 1 wherein each respective phase of the first set of balanced three-phase windings is phase shifted 30 electrical degrees from the respective phases of the second set of balanced three-phase windings for reducing the torque ripple.

3. The motor drive system of claim 1 wherein the number of rotor poles is 10 or 14 and the number of stator slots is 12.

4. The motor drive system of claim 1 wherein the number of rotor poles is 14 or 16 and the number of stator slots is 18.

5. The motor drive system of claim 1 wherein a combination of a number of rotor poles to a number of stator slots have a least common multiple of at least 36.

6. The motor drive system of claim 5 wherein the concentrated windings include a winding factor of greater than 0.7.

7. The motor drive system of claim 1 wherein the diode bridge rectifier is a six-leg diode bridge rectifier.

8. The motor drive system of claim 1 further including a power control unit for controlling power flow through the diode bridge rectifier.

9. The motor drive system of claim 1 wherein the power control unit utilizes a buck-boost topologies.

10. The motor drive system of claim 1 wherein the power control unit utilizes a buck topologies.

11. The motor drive system of claim 1 wherein the power control unit utilizes a boost topologies.

12. The motor drive system of claim 1 wherein the number of stator slots in an even integer.
